(19) United States
(12) Patent Application Publication
(10) Pub. No.: US 2020/0253206 A1
(43) Pub. Date: Aug. 13, 2020

(54) BUSINESS METHOD OF PROVIDING HIGH STABILITY NON-IONIC N-VINYL BUTYROLACTAM IODINE AND PREPARATION METHOD THEREFOR

(71) Applicant: Shanghai Yuking Water Soluble Material Tech Co., Ltd., Shanghai (CN)

(72) Inventors: Yu Wang, Shanghai (CN); Zhan Chen, Shanghai (CN)

(73) Assignee: Shanghai Yuking Water Soluble Material Tech Co., Ltd., Shanghai (CN)

(21) Appl. No.: 16/860,373

(22) Filed: Apr. 28, 2020

Related U.S. Application Data
(63) Continuation-in-part of application No. 16/126,206, filed on Sep. 10, 2018.
Application No. 16/126,206 is a continuation of application No. 13/978,367, filed on Jul. 3, 2013, now abandoned.

(30) Foreign Application Priority Data
Jan. 7, 2011 (CN) 201110002771.0

(51) Int. Cl. A01N 43/36; A01N 59/12

(52) U.S. Cl. CPC A01N 43/36; A01N 59/12

(57) ABSTRACT

A business method is provided for the sale of a high-stability non-ionic N-vinyl butyrolactam iodine solution in which high-stability non-ionic N-vinyl butyrolactam iodine is dissolved in water, then citric acid, at least one iodine ion stabilizing agent, at least one non-ionic surfactant and at least one emulsifier are added, then the pH is adjusted to 5 with at least one pH adjusting agent, so as to prepare the high-stable non-ionic N-vinyl butyrolactam iodine solution. The stability of the high-stable non-ionic N-vinyl butyrolactam iodine solution is such that a degradation rate of iodine activity at 85° C. for 15 hours is less than 6.0% thereby allowing for a warranty to be provided consistent with this novel level of stability.

### RELATED APPLICATIONS

This application is a continuation-in-part of U.S. Utility application Ser. No. 16/126,206 filed Sep. 10, 2018; that in turn is a continuation of U.S. Utility application Ser. No. 13/978,367 filed Jul. 3, 2013; that in turn is a US National Phase filing of PCT/CN11/78578 filed Aug. 18, 2011; the contents of which are hereby incorporated by reference.

### FIELD OF TECHNOLOGY

The present invention relates to the technical field of preparing solutions, especially to the technical field of preparing non-ionic N-vinyl butyrolactam iodine solutions, in particular to a high-stable non-ionic N-vinyl butyrolactam iodine solution and preparation method thereof.

### DESCRIPTION OF RELATED ARTS

Non-ionic N-vinyl butyrolactam iodine (PVP-I) is a kind of amorphous powder having a yellowish-brown to reddish-brown color, an unshaped iodine complex formed by complexing non-ionic N-vinyl butyrolactam (PVP) with iodine, PVP-I for short, and an indophor. PVP-I is an excellent disinfectant, as documented in the 1990 edition of the Chinese Pharmacopoeia. PVP-I can maintain a bactericidal power for a longer time, is a broad-spectrum strong disinfectant, has a relatively strong role in killing viruses, bacteria, fungi and mold spores, and is approved by the Chinese Pharmacopoeia as a sanitizer that can be used directly on human bodies.

PVP-I is easily dissolved in water, does not cause irritation, allergy and poisoning to skin and mucous membranes, and thus PVP-I has a very good evaluation both domestically and abroad. PVP-I not only can be used as an aqueous solution, but also can be used in a solid form in some special applications. This allows the PVP-I complex to be widely used in sterilization, disinfection of various fields, expands the application range of iodine, and the PVP-I complex can be widely applied in the disinfection of domestic hospitals. At the present stage, the most widely used solution agent is the PVPI solution in clinic, but the stability of the PVP-I disinfectant produced by traditional methods is not ideal. During the storage of PVP-I, due to easy decomposition and sublimation, the content of its available iodine is decreased slightly, and the PVP-I cannot meet the quality standard of the required usage. In addition, PVP-I is more unstable especially in summer, which makes long-term storage and use of the disinfectant problematic. As a result, PVP-I solutions that have thermally degraded are often returned to the manufacturer with refund requests. Leading to difficulties in maintaining stock and a lost of goodwill.

Therefore, there is an urgent need to provide a highly-stable, non-ionic N-vinyl butyrolactam iodine (PVP-I) solution, whose stability is high, thereby facilitating long-term storage and use. There further exists a need to provide a thermally stable PVP-I solution as part of a business method to promote storage and reduce product returns.

### BRIEF DESCRIPTION OF THE DRAWINGS

The present invention is further detailed with respect to the following drawings that are intended to show certain aspects of the present invention but should not be construed as a limit on the practice of the present invention.

FIG. 1 is a graph of the infrared spectrum showing the difference between the PVP-K30 used in the present invention and the conventional PVP-K30, wherein the red curve represents the PVP-K30 used in the present invention, and the purple curve is the conventional PVP-K30.

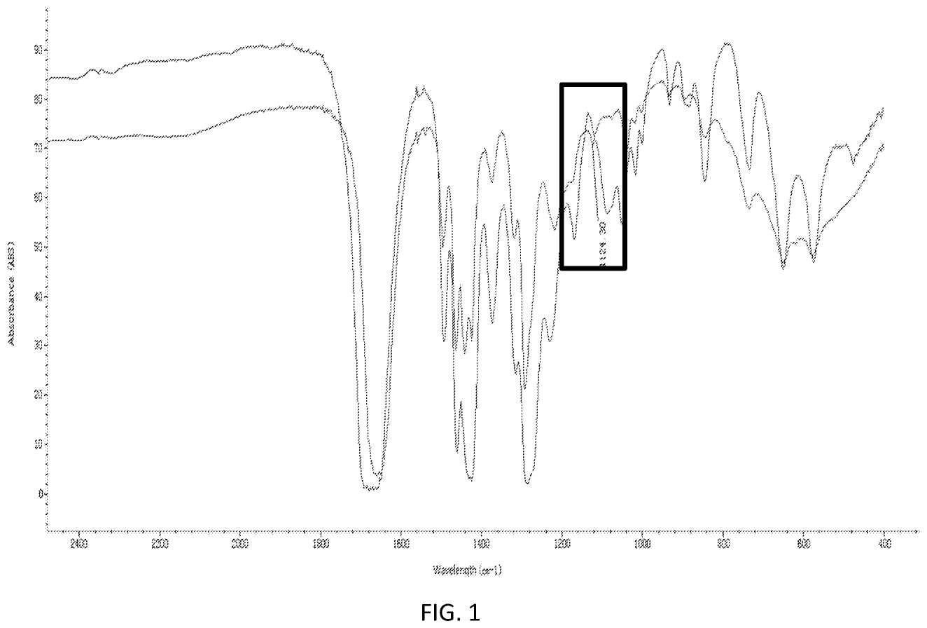

### SUMMARY OF THE INVENTION

Aspects of the present invention generally pertain to a high-stability non-ionic N-vinyl butyrolactam iodine solution and method of preparation thereof. The stability of the high-stability non-ionic N-vinyl butyrolactam iodine solution is high, thereby facilitating long-term storage and use, and thus the high-stability non-ionic N-vinyl butyrolactam iodine solution is suitable for large-scale popularization. A business method is provided for selling a PVP-I solution with superior storage stability compared to conventional versions.

In order to realize the above aims, in a first aspect of the present invention, a preparation method of a high-stability non-ionic N-vinyl butyrolactam iodine solution is provided and characterized in that, high-stability non-ionic N-vinyl butyrolactam iodine meeting a condition that the degradation rate after the high-stability non-ionic N-vinyl butyrolactam iodine is positioned at 85° C. for 15 hours is less than 6.0% is dissolved in water, then citric acid, at least one iodine ion stabilizing agent, at least one non-ionic surfactant, and at least one emulsifier are added, then the pH is adjusted to 5 with at least one pH adjusting agent, so as to prepare the high-stability non-ionic N-vinyl butyrolactam iodine solution.

The iodine ion stabilizing agent, the non-ionic surfactant, the emulsifier, the pH adjusting agent and the high-stability non-ionic N-vinyl butyrolactam iodine can be any suitable agents. Preferably, the iodine ion stabilizing agent is potassium iodate, the non-ionic surfactant is Tween 20, the emulsifier is polyethylene glycol 200, and the pH adjusting agent is sodium hydroxide.

A person skilled in the art can add suitable amounts of the high-stability non-ionic N-vinyl butyrolactam iodine, the citric acid, the iodine ion stabilizing agent, the non-ionic surfactant, and the emulsifier according to their level of experience. Preferably, the high-stability non-ionic N-vinyl butyrolactam iodine is 20 g, the citric acid is 0.5-5.0 g, the iodine ion stabilizing agent is 0.1-1.0 g, the non-ionic surfactant is 0.1-1.0 g, and the emulsifier is 0.5-5.0 g.

The high-stability non-ionic N-vinyl butyrolactam iodine can be provided in any suitable manner. Preferably, the high-stability non-ionic N-vinyl butyrolactam iodine is formed by complexing PVP-K30, iodine, and at least one grinding aid at a temperature of 60° C.-90° C. For example, the high-stability non-ionic N-vinyl butyrolactam iodine can be complexed by grinding at a high speed of 20000-30000 r/min for 50 to 60 seconds.

The molecular weight Mw of PVP-K30 is 48000-50000, the residual monomer content of VP is 0.1%-0.2%, the infrared spectrum has characteristic absorption peaks at 1100-1250 cm−1. PVP-K30 that meets the above conditions can make the free iodine in the solution low and stable, greatly reducing the irritation of the non-ionic N-vinylbutyrolactam iodine solution.

The grinding aid can adopt any suitable grinding aid. More preferably, the grinding aid is one or more selected from the group of sodium chloride, sodium citrate, sodium carbonate, and sodium phosphate.

The person skilled in the art can add suitable amounts of PVP-K30, the iodine, and the grinding aid according to their level of experience. Preferably, the PVP-K30 is 46-47 g, the iodine is 7 g, and the grinding aid is 0.19-0.27 g.

The high-stability non-ionic N-vinyl butyrolactam iodine can be any high-stability non-ionic N-vinyl butyrolactam iodine meeting a condition that the degradation rate after the high-stability non-ionic N-vinyl butyrolactam iodine is positioned at 85° C. for 15 hours is less than 6.0%. Preferably, the high-stability non-ionic N-vinyl butyrolactam iodine is YuKing®-PVPI (H) prepared by Shanghai Yu King New Material Technology Development Co., Ltd.,

In a second aspect of the present invention, a high-stability non-ionic N-vinyl butyrolactam iodine solution is provided and characterized in that, the high-stability non-ionic N-vinyl butyrolactam iodine solution is obtained by the preparation method of a high-stability non-ionic N-vinyl butyrolactam iodine solution mentioned above.

The beneficial effects of the present invention are as follows:

1. The present invention prepares the high-stability non-ionic N-vinyl butyrolactam iodine solution by dissolving high-stability non-ionic N-vinyl butyrolactam iodine in water, adding citric acid, at least one iodine ion stabilizing agent, at least one non-ionic surfactant, and at least one emulsifier, adjusting the pH to 5 with at least one pH adjusting agent, and the stability of the high-stability non-ionic N-vinyl butyrolactam iodine solution prepared is high, thereby facilitating long-term storage and use, thus the high-stability non-ionic N-vinyl butyrolactam iodine solution is suitable for large-scale popularization.
2. The present invention does not use the conventional PVPI, and instead uses the high-stability non-ionic N-vinyl butyrolactam iodine formed by complexing PVP-K30, iodine and at least one grinding aid at a temperature of 60° C.-90° C., such as the YuKing®-PVPI (H) product prepared by Shanghai Yu King New Material Technology Development Co., Ltd. Compared with the conventional PVPI, the stability of the YuKing®-PVPI (H) is high, so as to contribute to the stability of the high-stability non-ionic N-vinyl butyrolactam iodine solution being prepared.

### DETAILED DESCRIPTION OF THE PREFERRED EMBODIMENT

The present invention has utility as a non-ionic N-vinylbutyrolactam iodine (PVP-I) solution that is highly stable which enables long-term storage and use of the disinfectant.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

The present invention relates to a method for preparing a non-ionic N-vinylbutyrolactam iodine (PVP-I) solution, comprising: dissolving a solid non-ionic N-vinylbutyrolactam iodine (PVP-I) in water, then adding citric acid, iodide ion stabilizer, non-ionic surfactant and emulsifier, and adjusting the pH to 5 with a pH regulator.

Among them, the iodide ion stabilizer is preferably potassium iodate, the non-ionic surfactant is preferably Tween-20, the emulsifier is preferably polyethylene glycol 200, and the pH adjuster is preferably sodium hydroxide.

Solid non-ionic N-vinylbutyrolactam iodine (PVP-I) is formed by complexing PVP-K30, iodine and grinding aid at a temperature of 60° C.-90° C., wherein the molecular weight Mw of PVP-K30 is 48000-50000, infrared spectrum has characteristic absorption peak at 1100-1150 cm⁻¹, and the molecular structure formula of PVP-K30 is as follows:

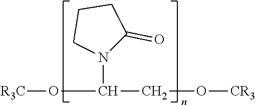

Wherein, R is an alkyl group, an acyl group or a derivative thereof.

In the current market, the preparing method of PVP-K30 usually uses hydrogen peroxide as an initiator for aqueous solution polymerization; and the terminal groups of PVP-K30 polymers are generally hydroxyl (—OH) and aldehyde (—CHO), with the characteristics of high activity and easy to be oxidized; when PVP-K30 made in this method is used as a raw material for PVP-I related products, the end groups are easy to react with iodine, resulting in the product unstable on effective iodine and free iodine.

According to the preparation method provided by the present invention, the terminal groups of PVP-K30 is R₃C—O—, which has good terminal group stability and is not easy to be oxidized. When used in PVP-I products, it can effectively ensure the high stability of effective iodine and free iodine and conducive to long-term storage and use of PVPI products.

In order to clarify the difference between the PVP-K30 used in the present invention and the conventional PVP-K30, a comparison chart of the infrared spectrum shown below is provided, wherein the red curve represents the PVP-K30 used in the present invention, and the purple curve is the conventional PVP-K30. It can be clearly seen that the red curve has a characteristic absorption peak at 1124.30 cm⁻¹ (see the black frame).

The non-ionic N-vinylbutyrolactam iodine (PVP-I) solution prepared by the above method has high stability, is beneficial to long-term storage and use, and can expand the range of product use. For example, it could be used as an oral product for treating harmful pathogenic microorganisms in poultry and livestock.

Specific examples are provided to illustrate the preparation method of the present invention.

### Example 1

(1) 46 g of PVP-K30, 7 g of iodine, and 0.2 g of sodium citrate were complexed at 65° C. to prepare a non-ionic N-vinyl caprolactam iodine (PVP-I) powder for use, wherein the characteristics of PVP-K30 are: molecular weight Mw is 49500, infrared spectrum has a characteristic absorption peak at 1100-1150 cm⁻¹, and the terminal group is (H₃C)₃C—O—.

(2) Take 20 g of the PVP-I powder prepared in (1), dissolve it with an appropriate amount of water, then add 0.1 g of potassium iodate, 1.0 g of Tween-20, 5.0 g of polyethylene glycol 200 and 0.5 g of citric acid, stir well, and adjust the pH to 5.0 with 0.2 mol/L sodium hydroxide solution, add water to bring the volume to 200 ml, and shake well.

### Example 2

(1) 46 g of PVP-K30, 7 g of iodine, and 0.2 g of sodium citrate were complexed at 85° C. to prepare a non-ionic N-vinyl caprolactam iodine (PVP-I) powder for use, wherein the characteristics of PVP-K30 are: molecular weight Mw is 48800, infrared spectrum has a characteristic absorption peak at 1100-1150 cm⁻¹, and the terminal group is H₃C—O—.

(2) Take 20 g of the PVP-I powder prepared in (1), dissolve it with an appropriate amount of water, then add 0.5 g of potassium iodate, 0.5 g of Tween-20, 2.5 g of polyethylene glycol 200 and 2.5 g of citric acid, stir well, and adjust the pH to 5.0 with 0.2 mol/L sodium hydroxide solution, add water to bring the volume to 200 ml, and shake well.

### Example 3

Take 20 g of the PVP-I powder prepared in (1) of Example 2, dissolve it with an appropriate amount of water, then follow the step (2) of Example 1, add 0.1 g of potassium iodate, 1.0 g of Tween-20, 5.0 g of polyethylene glycol 200 and 0.5 g of citric acid in sequence, stir well, and adjust the pH to 5.0 with 0.2 mol/L sodium hydroxide solution, add water to bring the volume to 200 ml, and shake well.

### Example 4

Take 20 g of the PVP-I powder prepared in (1) of Example 2, dissolve it with an appropriate amount of water, then add 0.5 g of potassium iodate, 2.5 g of citric acid in sequence, stir well, and adjust the pH to 5.0 with 0.2 mol/L sodium hydroxide, add water to bring the volume to 200 ml, and shake well.

### Example 5

Take 20 g of the PVP-I powder prepared in (1) of Example 2, dissolve it with an appropriate amount of water, then add 0.5 g of Tween-20, 2.5 g of polyethylene glycol 200 and 2.5 g of citric acid in sequence, stir well, and adjust the pH to 5.0 with 0.2 mol/L sodium hydroxide solution, add water to bring the volume to 200 ml, and shake well.

### Example 6

(1) 46 g of PVP-K30, 7 g of iodine, 0.2 g of sodium citrate were complexed at 90° C. to prepare a non-ionic N-vinyl caprolactam iodine (PVP-I) powder for use, wherein the characteristics of PVP-K30 are: molecular weight Mw is 49500, the infrared spectrum has a characteristic absorption peak at 1100-1150 cm⁻¹, and the terminal group is (ClH₂CH₂C)₃C—O—.

(2) Take 20 g of the PVP-I powder prepared in (1), dissolve it with an appropriate amount of water, then add 1.0 g of potassium iodate, 0.1 g of Tween-20, 0.5 g of polyethylene glycol 200 and 5.0 g of citric acid, stir well, and adjust the pH to 5.0 with 0.2 mol/L sodium hydroxide solution, add water to bring the volume to 200 ml, and shake well.

### Example 7

(1) 46 g of PVP-K30, 7 g of iodine, and 0.2 g of sodium citrate were complexed at 85° C. to prepare non-ionic N-vinyl caprolactam iodine (PVP-I) powder for use, wherein the characteristics of PVP-K30 are: the molecular weight Mw is 49800, the infrared spectrum has a characteristic absorption peak at 1100-1150 cm⁻¹, and the terminal group is (H₃COC)₃C—O—.

(2) Take 20 g of the PVP-I powder prepared in (1), dissolve it with an appropriate amount of water, then add 0.35 g of potassium iodate, 0.75 g of Tween-20, 3.5 g of polyethylene glycol 200 and 3.5 g of citric acid, stir well, and adjust the pH to 5.0 with 0.2 mol/L sodium hydroxide solution, add water to bring the volume to 200 ml, and shake well.

### Comparative Example 1

(1) 46 g of conventional PVP-K30 purchased from the market, 7 g of iodine, and 0.2 g of sodium citrate were complexed at 85° C. to prepare a non-ionic N-vinyl caprolactam iodine (PVP-I) powder for use, wherein the characteristics of conventional PVP-K30 are: molecular weight Mw is 49800, infrared spectrum at 1100-1150 cm⁻¹ with no characteristic absorption peak.

(2) Take 20 g of the PVP-I powder prepared in (1), dissolve it with an appropriate amount of water, then add 0.1 g of potassium iodate, 1.0 g of Tween-20, 5.0 g of polyethylene glycol 200 and 0.5 g of citric acid, stir well, and adjust the pH to 5.0 with 0.2 mol/L sodium hydroxide solution, add water to bring the volume to 200 ml, and shake well.

### Comparative Example 2

Take 20 g of the PVP-I powder prepared in step (1) of Comparative Example 1, dissolve it with an appropriate amount of water, then add 0.1 g of potassium iodate and 0.5 g of citric acid in sequence, stir well, and adjust the pH to 5.0 with 0.2 mol/L sodium hydroxide, add water to bring the volume to 200 ml, and shake well.

### Comparative Example 3

Take 20 g of the PVP-I powder prepared in step (1) of Comparative Example 1, dissolve it with an appropriate amount of water, then add 1.0 g of Tween-20, 5.0 g of polyethylene glycol 200 and 0.5 g of citric acid in sequence, stir well, and adjust the pH to 5.0 with 0.2 mol/L sodium hydroxide, add water to bring the volume to 200 ml, and shake well.

### Comparative Example 4

Take 20 g of the PVP-I powder prepared in step (1) of Comparative Example 1, dissolve it with an appropriate amount of water, and then add 0.5 g of citric acid, stir well, and adjust the pH to 5.0 with 0.2 mol/L sodium hydroxide solution, add water to bring the volume to 200 ml, and shake well.

### Comparative Example 5

Take 20 g of the PVP-I powder prepared in step (1) of Comparative Example 1, dissolve it with an appropriate amount of water to dissolve, then add 0.35 g of potassium iodate, 0.75 g of Tween-20, 3.5 g of polyethylene glycol 200 and 3.5 g of citric acid, stir well, and adjust the pH to 5.0 with 0.2 mol/L sodium hydroxide solution, add water to bring the volume to 200 ml, and shake well.

The above groups of experimental samples were subjected to 80° C., 15 h stability acceleration test, the results are as follows:

| | | Effective iodine | |
|---|---|---|---|
| | Initial effective | content after | |
| | iodine | accelerated | |
| Number | content % | experiment % | change |
| Example 1 | 1.00 | 1.01 | +0.01 |
| Example 2 | 1.05 | 1.07 | +0.02 |
| Example 3 | 1.01 | 1.01 | 0 |
| Example 4 | 1.04 | 1.07 | +0.03 |
| Example 5 | 1.00 | 1.01 | 0 |
| Example 6 | 1.09 | 1.12 | +0.03 |
| Example 7 | 1.02 | 1.02 | 0 |
| Comparative | 1.02 | 0.89 | −0.13 |
| Example 1 | | | |
| Comparative | 1.02 | 0.88 | −0.14 |
| Example 2 | | | |
| Comparative | 1.00 | 0.85 | −0.15 |
| Example 3 | | | |
| Comparative | 0.98 | 0.82 | −0.16 |
| Example 4 | | | |
| Comparative | 1.03 | 0.90 | −0.13 |
| Example 5 | | | |

It can be seen from the above examples 1-7 that the effective iodine in the solution is stable. Under the partial acidity condition of pH 5-6, control the ratio of effective iodine to iodide ions, free iodine and iodate ions in the solution. The effective iodine, iodide ions and iodate will be in the dynamic equilibrium state of conversion:

I₂+H₂O [symbol] HI+HIO (1)

HIO [symbol] HIO₃+I₂+H₂O (2)

IO₃⁻+I⁻+H⁺ [symbol] I₂+H₂O (3)

That is, free iodine dissociated out of PVP-I reacts with water to generate HIO and I—, and HIO can further disproportionate the reaction to generate HIO₃. Under light, heating and other conditions, the content of free iodine decreases, resulting in the continuous dissociation of free iodine from N-vinylbutyrolactam iodine. Due to the reversibility of the above reaction, increasing the concentration of IO₃⁻ can make the reaction to generate IO₃⁻ difficult to proceed, and the reaction to generate I₂ can occur more easily. Therefore, increasing the concentration of IO₃⁻ in the solution can improve the stability of free iodine in the product, that is, improve the product stability.

The effective iodine content in PVP-I contains free iodine, which is released by complex iodine. When the system environment is stable, the two are in a dynamic equilibrium state. The essence of PVP-I product instability is that complex iodine continuously releases free iodine (I₂), and then free iodine is further converted into I⁻. The addition of IO₃⁻ is conducive to the positive reaction of reaction (3) occurs, generating more free iodine (I₂), so the content of free iodine is high, the effective iodine detection result is bound to increase, and also inhibits the process of complex iodine releasing free iodine, that is, stability is improved.

As a result of the improved stability provided by the present invention as to PVP-I solutions, a business method is enabled that allows one to sell PVP-I solutions in exchange of monetary remuneration and provide a warranty as to the stability of the solutions as measured by of a degradation rate of iodine activity at 85° C. held for 15 hours that is less than 6.0% of the iodine activity. As a result, PVP-I shelf life is extended leading to less returns of product for diminished iodine activity levels. The business method is enabled by order of component addition and in some embodiments, through the use of PVP-K30 as a component with an infrared spectrum having a characteristic absorption peak at 1100-1150 cm⁻¹.

In order to understand the further embodiments of the present invention clearly, the present invention is further exemplified with reference to the following examples. The raw materials and equipment involved in the examples are as follows:

Experimental materials: ordinary PVPI (YuKing®-PVPI (C), Shanghai Yu King New Material Technology Development Co., Ltd., prepared by complexing 6.5 g iodine and 43.5 g PVP-K30 at 60° C. for 2 hours), high-stability PVPI (YuKing®-PVPI (H), Shanghai Yu King New Material Technology Development Co., Ltd.), potassium iodate (AR), Tween-20 (CP), polyethylene glycol 200 (CP), citric acid (AR), sodium hydroxide (AR). The above mentioned reagents are commercially available. Instruments and equipments:

| Instrument name | Model | Place of origin |
|---|---|---|
| Air blowing thermostatic | DZF-6021 | Shanghai Suopu |
| drying oven | | Instrument Co., Ltd. |
| Electronic analytical | FA2004 | Shanghai Liangping |
| balance | | Instrument Co., Ltd. |
| Alkali burette | 50 ml | Shanghai Heqi Glass |
| | | Instrument Co., Ltd. |

### Embodiment 1

20 g ordinary PVPI prepared by Shanghai Yu King New Material Technology Development Co., Ltd. is dissolved by adding an appropriate amount of water, the pH is adjusted to 5 with 0.2 mol/L sodium hydroxide solution, and the PVPI solution is diluted with water to 200 ml.

### Embodiment 2

20 g high-stability PVPI prepared by Shanghai Yu King New Material Technology Development Co., Ltd. is dissolved by adding an appropriate amount of water, the pH is adjusted to 5 with 0.2 mol/L sodium hydroxide solution, and the PVPI solution is diluted with water to 200 ml.

### Embodiment 3

20 g ordinary PVPI prepared by Shanghai Yu King New Material Technology Development Co., Ltd. is dissolved by adding an appropriate amount of water, in addition 0.5 g potassium iodate, 0.5 g Tween-20, 2.5 g polyethylene glycol 200 and 2.5 g citric acid are dissolved in purified water and added into the PVPI solution, the pH is adjusted to 5 with 0.2 mol/L sodium hydroxide solution, and the PVPI solution is diluted with water to 200 ml and is ready for use.

### Embodiment 4

20 g high-stability PVPI prepared by Shanghai Yu King New Material Technology Development Co., Ltd. is dissolved by adding an appropriate amount of water, in addition 0.5 g potassium iodate, 0.5 g Tween-20, 2.5 g polyethylene glycol 200 and 2.5 g citric acid are dissolved in purified water and added in the PVPI solution, the pH is adjusted to 5 with 0.2 mol/L sodium hydroxide solution, and the PVPI solution is diluted with water to 200 ml and is ready for use.

### Embodiment 5

20 g high-stability PVPI prepared by Shanghai Yu King New Material Technology Development Co., Ltd. is dissolved by adding an appropriate amount of water, in addition 1.0 g potassium iodate, 0.1 g Tween-20, 0.5 g polyethylene glycol 200 and 5.0 g citric acid are dissolved in purified water and added into the PVPI solution, the pH is adjusted to 5 with 0.2 mol/L sodium hydroxide solution, and the PVPI solution is diluted with water to 200 ml and is ready for use.

### Embodiment 6

20 g high-stability PVPI prepared by Shanghai Yu King New Material Technology Development Co., Ltd. is dissolved by adding an appropriate amount of water, in addition 0.1 g potassium iodate, 1.0 g Tween-20, 5.0 g polyethylene glycol 200 and 0.5 g citric acid are dissolved in purified water and added into the PVPI solution, the pH is adjusted to 5 with 0.2 mol/L sodium hydroxide solution, and the PVPI solution is diluted with water to 200 ml and ready for use.

### Embodiment 7: Stability Test

The PVPI solutions prepared in Embodiments 1-6 mentioned above are sealed in a plastic bottle respectively, and placed in the air blowing thermostatic drying oven to be accelerated at 85° C. for 15 h, then measured the available iodine content according to the USP method: 2 copies of 20 ml of a sample solution are pipetted accurately and transferred into an iodine flask respectively, and each is titrated with 0.01 mol/L sodium thiosulfate standard solution until the color is light yellow, 2 ml starch indicator is added, and the titration continues until the blue color disappears, the volume of the sodium thiosulfate titration solution used is recorded and the available iodine content of the solution is calculated, and the results are as follows:

Table 1 the available iodine contents and the stabilities of PVPI solutions with pH 5 stored at 85° C. for 15 h

| | Initial | available | changed |
|---|---|---|---|
| | available | iodine | value of |
| | iodine | content | available |
| Number | content (%) | (%) after 15 h | iodine (%) |
| Embodiment 1 | 1.02 | 0.78 | −23.35 |
| Embodiment 2 | 1.02 | 0.97 | −4.35 |
| Embodiment 3 | 1.01 | 0.97 | −3.26 |
| Embodiment 4 | 1.03 | 1.01 | −1.57 |
| Embodiment 5 | 1.03 | 1.01 | −1.95 |
| Embodiment 6 | 1.02 | 1.00 | −1.75 |

Note:
The available iodine content is calculated based on the solution.

For different storage conditions and different pH values have relatively great effects on the stability of the povidone-iodine (PVPI) solution, this experiment adopts the same storage container and the same pH value to investigate the stabilities of two groups of one solution. The results show that only adjusting the pH to 5 with sodium hydroxide is not ideal to the maintaining the stability of the povidone-iodine solution, but when potassium iodate, Tween-20, polyethylene glycol 200, and citric acid are added, the drop of the concentration of the available iodine of the povidone-iodine solution is controlled effectively. The reasons are that: Potassium iodate is an iodine ion inhibitor, when the PVPI reacts reversely, the increasing of the iodine ions can inhibit this reaction, thereby ensuring the stability of the solution; sodium hydroxide is a pH adjusting agent, PVPI itself has a relatively strong acidity, the solution is rather unstable, but when the pH is adjusted to 5 with sodium hydroxide, the stability of the solution can be maintained relatively well.

Therefore, there are two key factors to the preparation of the high-stability PVPI solution: first is to require PVPI powders with good stability; second is to add corresponding additives, the iodine ion stabilizing agent such as potassium iodate, the non-ionic surfactant such as Tween-20, the emulsifier such as polyethylene glycol 200, citric acid, and the pH adjusting agent such as sodium hydroxide during the preparation of the solution. The synergistic effect between the two factors can greatly improve the stability of the solution, which is critical to the long-term storage of the povidone-iodine disinfectant.

To sum up, the stability of the high-stability non-ionic N-vinyl butyrolactam iodine solution of the present invention is high, thereby facilitating long-term storage and use, thus the high-stability non-ionic N-vinyl butyrolactam iodine solution is suitable for large-scale popularization.

In the present specification, the present invention has been described according to the particular embodiments. But as will be understood by one having ordinary skill in the art, these embodiments can be modified or changed without departure from the spirit and scope of the present invention. Therefore, the specification described above is exemplary only and not intended to be limiting.

I claim:

1. A business method comprising:
preparing a non-ionic N-vinylbutyrolactam iodine (PVP-I) solution, the method comprising:
dissolving a solid non-ionic N-vinylbutyrolactam iodine (PVP-I) in water;
then adding the following: citric acid, at least one iodine ion stabilizing agent, at least one non-ionic surfactant, and at least one emulsifier; and
then adjusting pH to 5 with at least one pH adjusting agent, so as to prepare the high-stability N-vinyl butyrolactam iodine solution; and
selling the solution with a warranty of a degradation rate of iodine activity at 85° C. for 15 hours is less than 6.0%.

2. The method of claim 1 wherein the high-stability N-vinyl butyrolactam iodine solution meets a condition that the degradation rate after the high-stability N-vinyl butyrolactam iodine solution is positioned at 85° C. for 15 hours is less than 6.0% of the available iodine in the prepared N-vinyl butyrolactam iodine solution.

3. The method of claim 1 wherein the at least one iodide ion stabilizer is potassium iodate.

4. The method of claim 1 wherein the at least one non-ionic surfactant is Tween-20.

5. The method of claim 1 wherein the at least one emulsifier is polyethylene glycol 200.

6. The method of claim 1 wherein the at least one pH adjuster is sodium hydroxide.

7. The method of claim 1 wherein the solid non-ionic N-vinylbutyrolactam iodine (PVP-I) is formed by complexing PVP-K30, iodine, and a grinding aid.

8. The method of claim 7 wherein the PVP-K30, iodine, and grinding aid are complexed at a temperature of 60° C.-90° C.

9. The method of claim 7 wherein the molecular weight Mw of the PVP-K30 is 48000-50000.

10. The method of claim 7 wherein the PVP-K30 infrared spectrum has characteristic absorption peak at 1100-1150 cm⁻¹.

11. The method of claim 7 wherein the PVP-K30 has a molecular structure formula of: 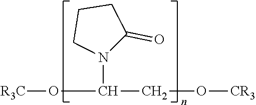
Wherein, R is an alkyl group, an acyl group or a derivative thereof.

12. A business method comprising:
preparing a high-stability N-vinyl butyrolactam iodine solution by:
dissolving N-vinyl butyrolactam iodine in water, the N-vinyl butyrolactam iodine formed by complexing PVP-K30, iodine, and a grinding aid, the PVP-K30 infrared spectrum has characteristic absorption peak at 1100-1150 cm⁻¹;
then adding the following: citric acid, at least one iodine ion stabilizing agent, at least one non-ionic surfactant, and at least one emulsifier; and
then adjusting pH to 5 with at least one pH adjusting agent, so as to prepare the high-stability N-vinyl butyrolactam iodine solution; and
selling the solution with a warranty of a degradation rate of iodine activity at 85° C. for 15 hours is less than 6.0%.

13. The method of preparing a high-stability N-vinyl butyrolactam iodine solution according to claim 12, where the iodine ion stabilizing agent is potassium iodate, the emulsifier is polyethylene glycol 200, and the pH adjusting agent is sodium hydroxide.

14. The method of preparing a high-stability N-vinyl butyrolactam iodine solution according to claim 12, where 20 g of the high-stability N-vinyl butyrolactam iodine is prepared with 0.5-5.0 g of the citric acid, 0.1-1.0 g of the iodine ion stabilizing agent, 0.1-1.0 g of the non-ionic surfactant and 0.5-5.0 g of the emulsifier.

15. The method of preparing a high-stability N-vinyl butyrolactam iodine solution according to claim 12, where the high-stability N-vinyl butyrolactam iodine is formed by complexing PVP-K30; with iodine, and using at least one grinding aid at a temperature of 60° C.-90° C.

16. The method of preparing a high-stability N-vinyl butyrolactam iodine solution according to claim 15, where the grinding aid is selected from the group consisting of sodium chloride, sodium citrate, sodium carbonate, and sodium phosphate.

17. The method of preparing a high-stability N-vinyl butyrolactam iodine solution according to claim 15, wherein 46-47 g of said PVP-K30, 7 g of said iodine, and 0.19-0.27 g of said at least one grinding aid are combined.

18. A high-stable N-vinyl butyrolactam iodine solution obtained by the preparation method of a high-stable N-vinyl butyrolactam iodine solution according to claim 12.
